(19) United States
(12) Patent Application Publication
(10) Pub. No.: US 2025/0170838 A1
(43) Pub. Date: May 29, 2025

(54) Transport device with reduced fluid consumption

(71) Applicant: CANON KABUSHIKI KAISHA, Tokyo (JP)

(72) Inventors: Zollner Alfred, Eitting (DE); Zollner Werner, Eitting (DE)

(21) Appl. No.: 18/956,679

(22) Filed: Nov. 22, 2024

(30) Foreign Application Priority Data
Nov. 24, 2023 (EP) 23212064.2

(51) Int. Cl. B41J 13/08; B41J 11/00

(52) U.S. Cl. CPC B41J 13/08; B41J 11/0085

(57) ABSTRACT

A transport device is described, which is adapted to transport a recording medium on a transport belt through a printing unit. The conveyor belt has a plurality of holes that have a first cross-sectional area towards the recording medium. Air is pumped out of the holes by means of a negative pressure unit in order to build up a negative pressure in the holes. In the process, the fluid is pumped over a second cross-sectional area that is smaller as compared to the first cross-sectional area. As a result, relatively high holding forces on the recording medium can be achieved with relatively low fluid consumption.

### CROSS REFERENCE TO RELATED APPLICATIONS

This application claims the benefit of European Patent Application No. 23212064.2, filed Nov. 24, 2023, which is hereby incorporated by reference herein in its entirety.

### BACKGROUND OF THE DISCLOSURE

### Field of the Disclosure

This disclosure relates to a transport device adapted to guide a recording medium, in the form of a sheet or plate to be printed, through a printing unit of a printing device, in particular an ink jet printing device.

### Description of the Related Art

An inkjet printing device typically includes a printing unit with one or more print bars for different inks. A print bar can have one or more print heads, each with one or more nozzles. To print on a recording medium, the recording medium can be guided past a print head by means of a transport device in order to gradually print the pixels of different lines of a print image onto the recording medium.

The transport device can have a conveyor belt with a plurality of openings or holes through which a vacuum can be created in order to hold a recording medium on the conveyor belt. The vacuum can be created by a vacuum pump.

Directly neighboring sheet- or plate-shaped recording media can be transported on the conveyor belt at a certain distance from each other, so that gaps are created between the recording media in which the holes in the conveyor belt are not covered by a recording medium. Relatively high air flows can be created in these holes by the vacuum pump. Such an air flow between neighboring recording media can lead to a deflection of ink drops and thus to inaccuracies in the positioning of pixels of a printed image on the recording media. Furthermore, such air flows increase the air consumption and thus the energy consumption and the requirements for a vacuum pump.

### SUMMARY OF THE DISCLOSURE

The present disclosure deals with reducing the fluid consumption, in particular the air consumption, during the transport of a sheet- or plate-shaped recording medium, in particular in order to increase the print quality of a printing device and/or the efficiency of a transport device.

According to one aspect of the disclosure, a transport device for transporting a recording medium through a printing unit of a printing device is described. The transport device includes a conveyor belt and a movement unit configured to move the conveyor belt through the printing unit. The conveyor belt includes a plurality of holes between a front side and a rear side of the conveyor belt, wherein the recording medium is transported on the front side of the conveyor belt. The plurality of holes has a first cross-sectional area at the front of the conveyor belt (as a whole). The transport device further includes a negative pressure unit which is configured to generate a negative pressure in the plurality of holes of the transport belt by pumping out a fluid, in particular by pumping out air, so that a holding force is caused on the recording medium at the first cross-sectional area of the plurality of holes. Furthermore, the transport device is designed in such a way that the fluid is pumped through a second cross-sectional area, which is smaller than the first cross-sectional area, to build up the negative pressure.

### BRIEF DESCRIPTION OF THE DRAWINGS

In the following, embodiments of the disclosure are described in more detail with reference to the schematic drawing.

FIG. 1a shows a block diagram of an exemplary ink jet printing device.

FIG. 1b shows a block diagram of an exemplary transport device for a recording medium.

FIG. 1c shows a printing situation with a covered hole.

FIG. 1d shows a flow situation with an uncovered hole.

FIGS. 2a-2b show an exemplary conveyor belt with holes of variable cross-sectional area.

FIGS. 3a-3b show another exemplary conveyor belt with holes with a variable cross-sectional area.

FIGS. 4a-4b show a further exemplary conveyor belt with holes with a variable cross-sectional area.

FIGS. 5a-5b show exemplary positioning of an air inlet of a hole.

FIG. 6 shows a block diagram of an exemplary transport device with an aperture;

FIG. 7 shows a further exemplary conveyor belt with holes of variable cross-sectional area.

FIGS. 8a-8b show a top view of a conveyor belt with two exemplary hole arrangement geometries.

### DESCRIPTION OF THE EMBODIMENTS

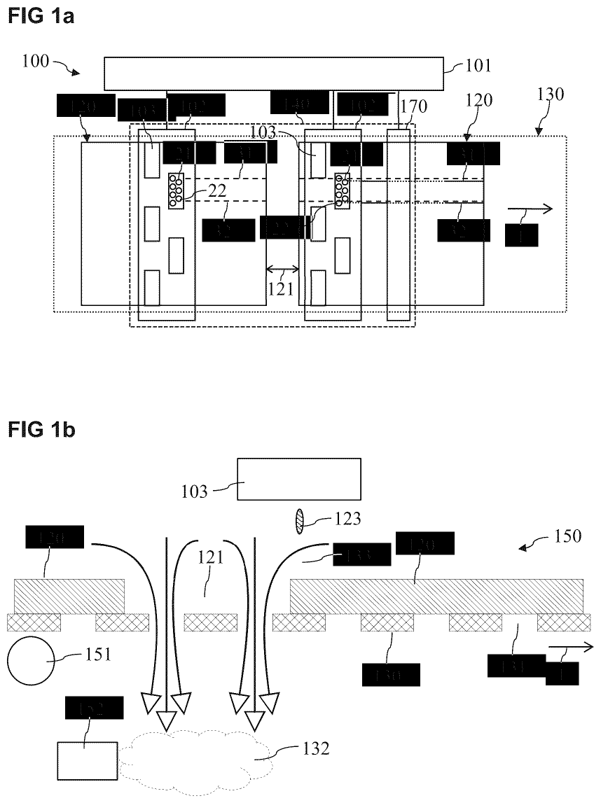

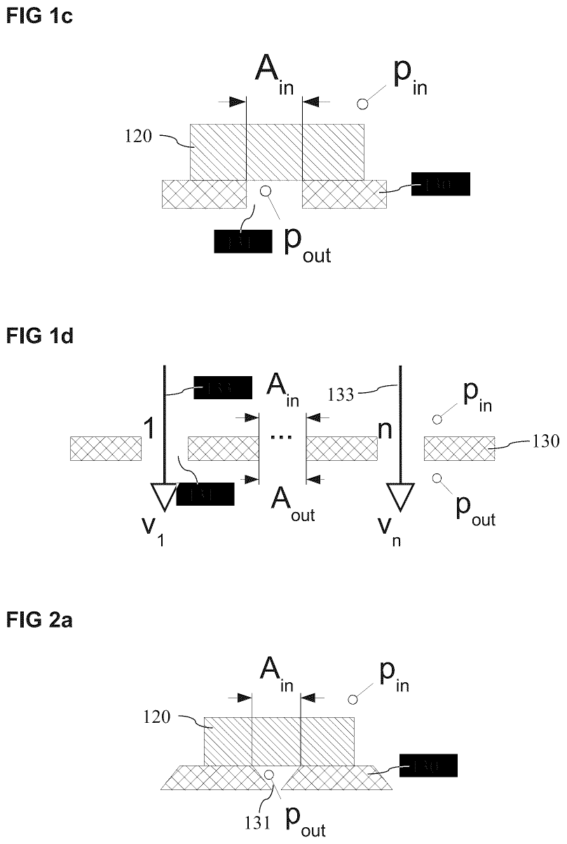

The printing device 100 shown in FIG. 1a is designed for printing on a sheet-shaped or plate-shaped recording medium 120. The recording medium 120 can be made of paper, cardboard, paperboard, metal, plastic, textiles, a combination thereof and/or other suitable and printable materials. The recording medium 120 is guided by a conveyor belt 130 along the transport direction 1 (shown by an arrow) through the printing unit 140 of the printing device 100. In the process, successive recording media 120 typically have a certain distance between them, so that a gap 121 is formed between neighboring recording media 120.

In the example shown, the printing unit 140 of the printing device 100 includes two print bars 102, wherein each print bar 102 can be used for printing with ink of a particular color (e.g. black, cyan, magenta and/or yellow and possibly MICR ink). Different print bars 102 can be used for printing with different inks, respectively. Furthermore, the printing unit 140 can include at least one fixing unit 170 that is configured to fix a printed image printed on the recording medium 120. If necessary, the fixing unit 170 can be arranged after each print bar 102 in order to at least partially fix the printed image applied by the respective print bar 102. The fixing unit 170 can also be arranged outside the printing unit 140.

The print bar 102 can include one or more print heads 103, which may be arranged in several rows next to each other, in order to print the pixels of different columns 31, 32 of a print image on the recording medium 120. In the example shown in FIG. 1a, the print bar 102 has five print heads 103, wherein each print head 103 prints the pixels of a group of columns 31, 32 of a print image onto the recording medium 120.

In the embodiment illustrated in FIG. 1a, each print head 103 of the printing unit 140 includes a plurality of nozzles 21, 22, wherein each nozzle 21, 22 is arranged to fire or eject drops of ink onto the recording medium 120. For example, the print head 103 of the printing unit 140 can include several thousand effectively utilized nozzles 21, 22 arranged along several rows transverse to the transport direction 1 of the recording medium 120. By means of the nozzles 21, 22 of the print head 103 of the printing unit 140, pixels of a line of a print image can be printed on the recording medium 120 transversely to the transport direction 1, i.e. along the width of the recording medium 120.

The printing device 100 further includes a control unit 101 (e.g. a control hardware and/or a controller) which is arranged to control the actuators of the individual nozzles 21, 22 of the individual print heads 103 of the printing unit 140 in order to apply the printed image to the recording medium 120 as a function of print data.

The printing unit 140 of the printing device 100 thus includes at least one printing bar 102 with K nozzles 21, 22, which can be controlled with a specific line cycle in order to print a line (transverse to the transport direction 1 of the recording medium 120) with K pixels or K columns 31, 32 of a printed image on the recording medium 120. In the example shown, the nozzles 21, 22 are immovable or fixed in the printing device 100, and the recording medium 120 is guided past the fixed nozzles 21, 22 at a specific transport speed.

In the printing device 100, rigid, plate-shaped recording media 120 in particular can be moved with the aid of the conveyor belt 130. FIG. 1b shows an exemplary transport device 150 for such a recording medium 120. The transport device 150 has a movement unit 151 (e.g. one or more drive wheels or drive rollers) through which the transport belt 130 can be moved. The conveyor belt 130 has a plurality of holes (or apertures) 131. By means of a negative pressure unit (in particular a negative pressure pump) 152, a negative pressure 132 is produced on a second side (in particular the lower or rear side) of the conveyor belt 130, which produces a force via the holes 131 on a recording medium 120 lying on the conveyor belt 130, so that the recording medium 120 is sucked onto the conveyor belt 130. In order to achieve sufficiently high forces, the conveyor belt 130 can have holes 131 with relatively large cross-sections or diameters and/or a relatively high number of holes 131.

The conveyor belt 130 typically has a relatively large number of apertures or holes 131 through which a fluid (in particular air) is sucked in order to build up the negative pressure 132 which draws a recording medium 120 to the conveyor belt 130. The negative pressure 132 is typically 10 mbar to 25 mbar and typically depends on the material of the recording medium 120. The holes 131 in the conveyor belt 130 typically have a diameter of 5 mm to 10 mm. Holes 131 with relatively large diameters have the disadvantage that the recording medium 120 can bend relatively strongly over the holes 131. Holes 131 with relatively small diameters have the disadvantage that only a relatively small force can be built up over the relatively small cross-sectional area to hold the recording medium 120. The force caused by a certain negative pressure 132 increases with the cross-sectional area of a hole 131. Conveyor belts 130 therefore preferably have holes 131 with a cross-sectional area that exhibit a compromise between the force generated and the bending effect on the recording medium 120.

As long as recording media 120 follow one another directly edge to edge without spacing, the fluid (in particular air) consumption of the transport device 150 is relatively low because the recording media 120 cover the holes 131 of the conveyor belt 130 and thus seal them. However, it may be advantageous or necessary to maintain a certain distance between directly successive recording mediums 120 (e.g. in order to synchronize or cycle a machining process). As a result, gaps 121 may occur between different recording mediums 120, in which the holes 131 of the conveyor belt 130 are no longer covered, and thus a fluid flow (in particular an air flow) 133 is caused through the uncovered holes 131. The gaps can have a variable length (in transport direction 1) between successive recording mediums 120.

The fluid flow 133 produced can have a relatively high flow velocity along the printing direction (i.e. along the transport direction 1), which can reduce the positioning accuracy of the printing unit 140 (in particular in the case of an inkjet printing device 100 by deflecting the ejected ink drops). FIG. 1b shows an example of an ink drop 123 ejected by the print head 103 of the inkjet printing device 100. The ink drop 123 can be deflected by the fluid flow 133 and thus hit the recording medium 120 at an incorrect position.

Furthermore, the fluid flow 133 leads to increased fluid consumption and thus to increased requirements and increased energy consumption of the vacuum unit 152 of the transport device 150.

FIG. 1c shows a hole 131 of the conveyor belt 120, which is completely covered by a recording medium 120. In the interior of the printing unit 140, i.e. at the front side (generally also referred to as the first side or alternatively as the top side) of the conveyor belt 130, the ambient pressure pᵢₙ is present. The external pressure pₒᵤₜ, which is applied to the rear side (generally also referred to as the second side or alternatively as the underside) of the conveyor belt 130, is generated by the vacuum unit 152. A pressure difference is thus created, which causes the recording medium 120 to be pressed against the conveyor belt 130. The force acting on the recording medium 120 depends on the cross-sectional area Aᵢₙ of the air inlet of the hole 131 (facing the recording medium 120) and on the pressure difference (pᵢₙ−pₒᵤₜ). The larger the cross-sectional area Aᵢₙ, the greater the force that is exerted on the recording medium 120 at the air inlet of the hole 131. The total force acting on the recording medium 120 corresponds to the sum of the forces of all holes 131 of the conveyor belt 130 covered by the recording medium 120. If the cross-sectional area Aᵢₙ of the air inlet of the holes 131 is reduced, then the total force is also reduced. In order to maintain the total force, the number n of holes 131 would have to be increased by the same amount. The total force F acting on the recording medium 120 is calculated from the total cross-sectional area n·Aᵢₙ of the holes 131 acting on the recording medium 120 and the pressure difference as F=n×Aᵢₙ(pᵢₙ−pₒᵤₜ).

FIG. 1d illustrates the situation in which the air inlet of the n holes 131 is not covered by a recording medium 120. The holes 131 shown in FIG. 1d have the same cross-sectional area both on the air inlet side and on the air outlet side, i.e. Aᵢₙ=Aₒᵤₜ. Due to the pressure difference (pᵢₙ−pₒᵤₜ), an air flow 133 with an average velocity v₁=vₙ is created at each hole 131. The total air consumption dV/dt is calculated as dV/dt=n×Aₒᵤₜ·vₙ. From this estimate it can be seen that the air consumption can be reduced by reducing the cross-sectional area Aₒᵤₜ, by reducing the number n of holes 131 and/or by reducing the air velocity vₙ (which is accompanied by a reduction in the pressure difference (pᵢₙ−pₒᵤₜ)). However, this has a negative effect on the holding force F that can be exerted on a recording medium 120.

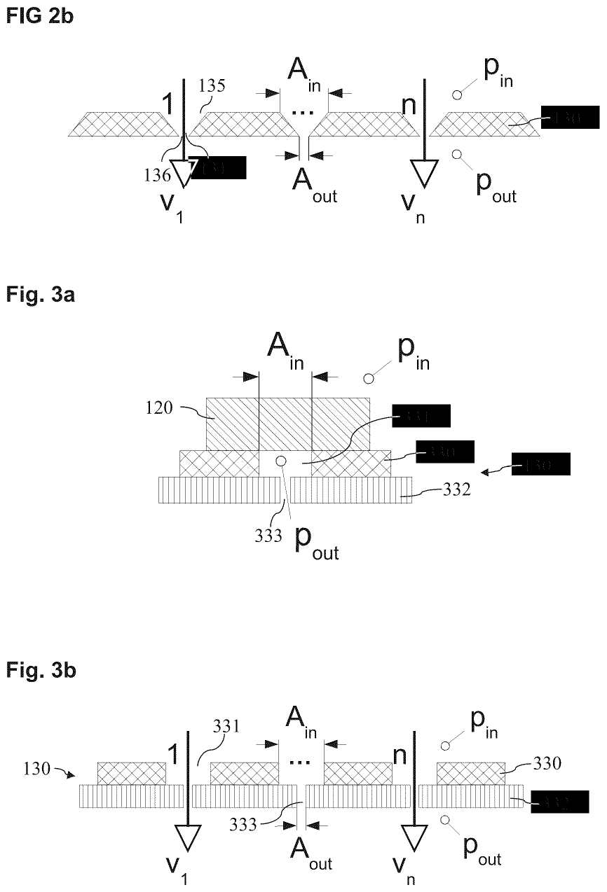

In the following, conveyor belts 130 for a transport device 150 are described in connection with FIGS. 2a to 7, which have openings or holes 131 with an adapted geometry, in particular with a variable cross-sectional area. A hole 131 can be formed in such a way that a prechamber with a relatively large inlet cross-sectional area Aᵢₙ is created on the front side of a conveyor belt 130 facing a recording medium 120 in order to effect relatively large holding forces on a recording medium 120. Furthermore, a hole 131 can be formed in such a way that an air outlet with a relatively small outlet cross-sectional area Aₒᵤₜ is formed on the opposite rear side of a conveyor belt 130 in order to reduce the air consumption caused by the hole 131. By geometrically dividing the holes 131 of a conveyor belt 130 into pre-chamber or inlet areas and outlet areas, the ‘holding force’ and ‘air consumption’ functions can thus be optimized separately. The inlet cross-sectional area of a pre-chamber determines the resulting force exerted on the recording medium 120 at a given negative pressure 132. On the other hand, the maximum air flow rate is determined by the outlet cross-sectional area of an air outlet.

FIGS. 2a and 2b show a conveyor belt 130 with one or more conical apertures or holes 131. A hole 131 has an air inlet with an inlet cross-sectional area Aᵢₙ that is larger than the outlet cross-sectional area Aₒᵤₜ of the air outlet, i.e. Aᵢₙ>Aₒᵤₜ. Thus, the cross-sectional area of the hole 131 is significantly smaller on the outer or rear side than on the inner or front side. The conical hole 131 has a diameter at the upper end 135 (with reference to FIG. 2b) of between 5 and 40 mm, more preferably between 10 and 30 mm, even more preferably between 15 and 25 mm, even more preferably between 18 and 22 mm. Further preferably, a diameter at the lower end 136 of the cone-shaped hole 131 is between ⅜ and ⅝ of the diameter at the upper end 135 of the hole, in particular between 2.5 and 20 mm, more preferably between 5 and 15 mm, still more preferably between 7.5 and 12.5 mm, still more preferably between 9 and 11 mm. The diameter ranges mentioned have proven to be very advantageous for transport media made of corrugated cardboard with thicknesses between 1 mm and 20 mm. For thinner transport media such as 300 μm thick paper, for example, conveyor belts with smaller hole diameters are preferable so that the transport medium does not bend in the holes 131. This results in a pre-chamber with an inlet cross-sectional area Aᵢₙ on the front side (i.e. on the top side) of the conveyor belt 130, through which a relatively high holding force can be achieved. On the other hand, the air consumption is determined by the outlet cross-sectional area Aₒᵤₜ on the rear side (i.e. on the second side) of the conveyor belt 130.

With cylindrical holes 131, it can happen that the initially empty conveyor belt cannot build up sufficient differential pressure to fix a recording medium on the conveyor bel 130t, because the cylindrical shape of the holes 131 allows a high air flow. It is therefore advantageous to design the holes 131 in a conical shape, as shown in FIGS. 2a and 2b, in order to limit the air flow accordingly. The relatively small outlet cross-sectional area can significantly reduce the air consumption. For example, the air consumption can be reduced to 1/16 or less depending on the transport speed of a recording medium 120 (compared to the case Aᵢₙ=Aₒᵤₜ). The outlet cross-sectional area is preferably dimensioned as a function of the transport speed in such a way that sufficient pressure equalization can still take place in the pre-chamber via the reduced barrel outlet in order to build up an unchanged high holding force Aᵢₙ·(pᵢₙ−pₒᵤₜ) on the recording medium 120 quickly enough following a gap 121. The smallest sensible hole diameter of the outlet cross-sectional area is determined by the degree of contamination to be expected. A lot of dust can accumulate in holes 131 with a small diameter, which then blocks the flow.

FIGS. 3a and 3b show a conveyor belt 130 with several layers 330, 332. A first layer 330 (facing the recording medium 120) has holes 331 with a relatively large inlet cross-sectional area Aᵢₙ. A second layer 332 (facing away from the recording medium 120) can have holes 333 with a relatively small outlet cross-sectional area Aₒᵤₜ at corresponding points. The two layers 330, 332 may be bonded together. The holes 333 through the second layer 332 can be made (drilled or punched) after the two layers 330, 332 have been bonded together. This can ensure that corresponding holes 331, 333 are directly above one another. A manufacturing process is also possible in which each layer 330, 332 is first structured separately using suitable tools and in which the layers 330, 332 are then joined together. Here too, a diameter of the hole 331 in the first layer (with reference to FIG. 3b) is preferably between 10 and 30 mm, more preferably between 15 and 25 mm, even more preferably between 18 and 22 mm. Further preferably, a diameter of the hole 333 in the second layer 333 is between ⅜ and ⅝ of the diameter of the hole 331 in the first layer, in particular between 5 and 15 mm, even more preferably between 7.5 and 12.5 mm, even more preferably between 9 and 11 mm.

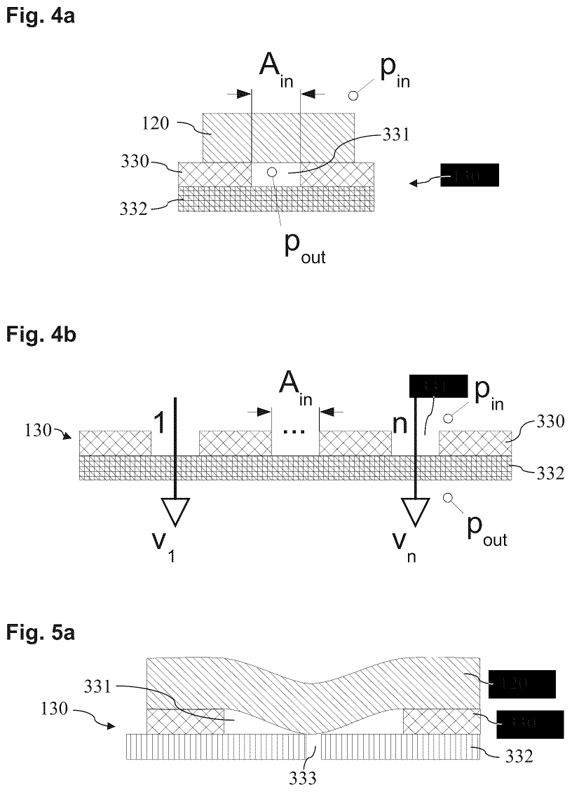

FIGS. 4a and 4b show a conveyor belt 130 in which an air-permeable fabric (e.g. a plastic fleece, a plastic or metal mesh, etc.) or a porous film is used as the second layer 332. The degree of air permeability of the material of the second layer 332 can be selected such that for an inlet cross-sectional area Aᵢₙ of a hole 331 of the first layer 330, an air permeability through the second layer 332 results which corresponds to a reduced outlet cross-sectional area Aₒᵤₜ. In the case of such fabrics or porous films, it must be taken into account that the diameters of the holes can be smaller here than in the other embodiments and that possible soiling due to dust or dust-ink adhesions can become more relevant here. For this reason, advantageous hole diameters in the fabric or film are preferably not smaller than 0.5 mm, and even more preferably not smaller than 0.7 mm. A ratio between an opening area and a covering area is between 10 and 70% for advantageous fabrics or porous films. To reduce soiling, cleaning methods such as sweeping, vacuuming or blowing are used in particular. Furthermore, a clogged fabric or porous film can also be blown free again using positive pressure instead of negative pressure. Service operations in which manual cleaning is carried out are also conceivable.

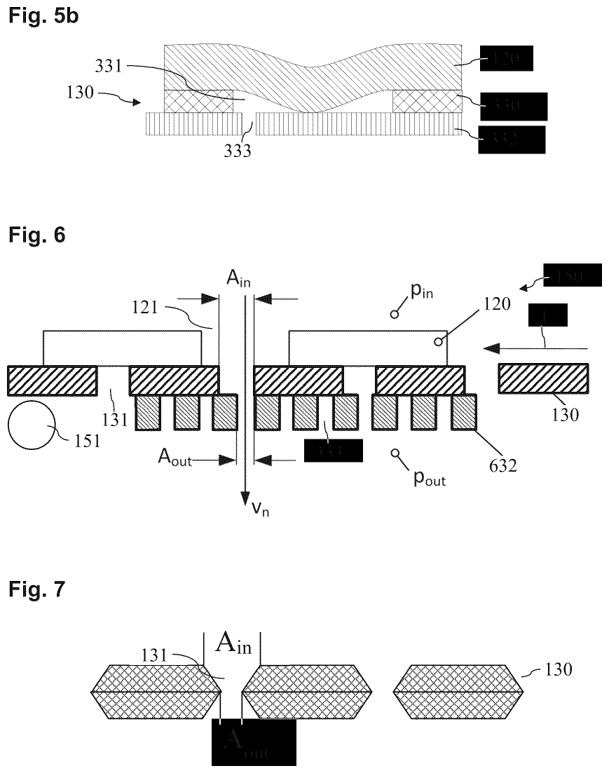

FIGS. 5a and 5b show exemplary arrangements of the holes 333 of the second layer 332 relative to the corresponding holes 331 of the first layer 330 of a multi-layer conveyor belt 130. When using a relatively large inlet cross-sectional area Aᵢₙ for a hole 331 of the first layer 330, substantial deflection of a covering recording medium 120 may occur. This may result in the underlying hole 333 of the second layer 332 (with the reduced outlet cross-sectional area Aₒᵤₜ) being closed by the deflected recording medium 120 (see FIG. 5a). As a result, the holding force on the recording medium 120 may be reduced. For this reason, a hole 333 of the second layer 332 can be positioned relatively close to the edge of the corresponding hole 331 of the first layer 330 (see FIG. 5b). In this way, closure of the hole 333 of the second layer 332 by a bent recording medium 120 can be reliably avoided.

With standard conveyor belt thicknesses between 1.5 mm and 3.0 mm and negative pressures between 15 and 30 mbar, no measurable deflection could be detected with a 3D profile scanner with hole diameters between 15 and 25 mm for corrugated cardboard transport media with a thickness between 1 and 20 mm.

FIG. 7 shows a conveyor belt 130 with a plurality of holes 131 which have a variable cross-sectional area. In particular, a hole 131 of the conveyor belt 130 at the front of the conveyor belt 130 has the inlet cross-sectional area Aᵢₙ. Furthermore, a hole 131 of the conveyor belt 130 has a reduced outlet cross-sectional area Aₒᵤₜ at at least one point along the section from the front to the rear of the conveyor belt 130. The hole 131 of a conveyor belt 130 can thus have a variable cross-sectional area along the section from the front side of the conveyor belt 130 to the rear side of the conveyor belt 130, wherein the hole 131 has an outlet cross-sectional area at least one point along the section, which is reduced compared to the inlet cross-sectional area at the front side of the conveyor belt 130. The reduced outlet cross-sectional area does not necessarily have to be present at the rear of the conveyor belt 130. It can thus be achieved that the fluid flow 133 is only affected by a reduced outlet cross-sectional area, while the holding force continues to be affected via a relatively large inlet cross-sectional area. The course of the wall of the hole 131 can be conical (see FIG. 2b) or have the shape of a diabolo gyroscope (see FIG. 7).

The transport device 150 typically has guide means which make it possible to guide the transport belt 130 stably and in a defined, reproducible manner through the printing unit 140. FIG. 6 shows the transport device 150 in which a cover 332 is used as a guide means to guide the transport belt 130 through the printing unit 140. The conveyor belt 130 rests on the cover 332 and is thus moved through the printing unit 140 in a defined manner by means of the movement unit 151. The cover 332 can have holes 333 with relatively small cross-sectional areas Aₒᵤₜ, and thus assume the function of a second layer of the conveyor belt 130. The reduction in air consumption can thus be achieved by a fixed aperture 632 with relatively small holes (in particular bores) 333. The holes 333 in the guide cover 332 can be arranged partially (only in one printing unit 140) or over the entire surface (along the entire transport device 150) under the transport belt 130. The spacing of the holes 333 in the cover 332 can be adapted to the cross-sectional area Aᵢₙ the holes 131 of the conveyor belt 130. In particular, the holes 333 in the fixed cover 332 can be designed and arranged in such a way that at any time below a hole 131 (in particular below all holes 131) of the conveyor belt 130 there is an effective hole in the cover 332 with a substantially constant effective cross-sectional area Aₒᵤₜ<Aᵢₙ. In this way, constant adhesive forces and air flows 133 can be achieved.

This document thus describes a transport device 150 for transporting a recording medium 120 through a printing unit 140 of a printing device 100. In particular, a sheet-shaped or plate-shaped recording medium 120 can be transported. In particular, the transport device 150 can be set up to transport several successive recording mediums 120, whereby directly successive recording mediums 120 can have gaps 121 between them. The transport device 150 can be part of an (inkjet) printing device 100.

The transport device 150 comprises a transport belt 130 which is arranged to carry a recording medium 120 on a front side of the transport belt 130 (also referred to as the substrate side or the front side). The conveyor belt 130 can have a width that corresponds at least to the width of the recording medium 120. The conveyor belt 130 can be designed as an endless belt which is guided via rollers or rollers from an output of the transport device 150 back to an input of the transport device 150. The transport device 150 includes at least one movement unit 151 (e.g. a drive roller), which is set up to move the transport belt 130 (with the recording medium 120 arranged thereon) through the printing unit 140. A printed image can then be printed gradually (e.g. line by line) on the recording medium 120. The transport belt can move at a certain transport speed. The transport speed is typically dependent on a line cycle at which the printing unit 140 prints lines of a print image on the recording medium 120. In particular, the transport speed increases as the line cycle increases.

The conveyor belt 130 includes a plurality of holes 131, 331, 333 between the front side and a rear side of the conveyor belt 130. The cross-sectional area of a hole 131, 331, 333 may depend on the flexibility of the recording medium 120 to be transported. Typically, a larger cross-sectional area can be selected as the flexibility of the recording medium 120 decreases. Typical cross-sectional areas are in the range of 20 mm² to 100 mm². The holes 131, 331, 333 may have a circular cross-section. Typically, a conveyor belt 130 has several hundred or several thousand holes 131, 331, 333.

The plurality of holes 131, 331, 333 can have a first cross-sectional area at the front of the conveyor belt 130. The first cross-sectional area can be the sum of the cross-sectional areas of the individual holes 131, 331, 333 of the plurality of holes 131, 331, 333. The cross-sectional area of a hole 131, 331, 333 at the front of the conveyor belt 130 is also referred to in this disclosure as the inlet cross-sectional area.

The transport device 150 includes a negative pressure unit 152 (in particular a negative pressure pump), which is set up to cause a negative pressure 132 in the plurality of holes 131, 331, 333 of the conveyor belt 130 by pumping out a fluid. In particular, a negative pressure 132 (also referred to as pout in this document) can be caused to exist in the plurality of holes 131, 331, 333 of the conveyor belt 130 (e.g. in prechambers of the holes 131, 331, 333) with respect to the pressure on the side of the recording carrier 120 facing away from the conveyor belt 130 (also referred to as pin in this document). As a result, a holding force on the recording medium 120 may be effected at the first cross-sectional area of the plurality of holes 131, 331, 333. If the first cross-sectional area corresponds to the sum of the inlet cross-sectional areas of the holes 131, 331, 333, the holding force may correspond to the total force F=n×Aᵢₙ·(pᵢₙ−pₒᵤₜ), where n is the number of holes 131, 331, 333 of the conveyor belt 130 acting on the conveyor belt 120.

The transport device 150 is designed such that the fluid for building up the negative pressure 132 is pumped out through a second cross-sectional area, which is smaller than the first cross-sectional area. The second cross-sectional area can correspond to the total cross-sectional area through which fluid (in particular air) is pumped out. The second cross-sectional area can depend on the transport speed of the transport device 150, and in particular increases with increasing transport speed or decreases with decreasing transport speed.

A transport device 150 is thus described which has a transport belt 130 with holes 131, 331, 333 in order to bring about a relatively large holding force on a recording medium 120 with a relatively large first cross-sectional area at the front of the transport belt 130. On the other hand, the fluid consumption can be reduced by pumping fluid over a relatively small second cross-sectional area to build up the negative pressure 132 for the holding force.

The conveyor belt 130 may have N holes 131, 331, 333 that can be utilized at a particular time of operation of the transport device 150 to affect a holding force on a recording medium 120. For example, the conveyor belt 130 may be configured such that the conveyor belt 130 has N holes 131, 331, 333 at any point in time or on average that can be covered with a recording medium 120. A circulating endless conveyor belt 130 can have approximately 2N holes 131, 331, 333 for this purpose. Furthermore, n may be the number of holes 131, 331, 333 that are actually covered by a recording medium 120 during operation of the transport device 150. N-n holes 131, 331, 333 may thus be located at a gap or gap 121 between recording media 120, thereby causing a fluid flow 133. The first cross-sectional area may be the sum of the inlet cross-sectional areas of the N holes 131, 331, 333. In this regard, the inlet cross-sectional areas for different holes 131, 331, 333 may be at least partially different. Alternatively, the holes 131, 331, 333 may have substantially the same inlet cross-sectional area.

The fluid can be pumped out through N corresponding holes 131, 331, 333 to cause the negative pressure 132 in the N holes 131, 331, 333 of the conveyor belt 130. The N corresponding holes 131, 331, 333 through which pumping takes place may each have an outlet cross-sectional area. A corresponding hole 131, 331, 333 may be a hole 131, 331, 333 in the conveyor belt 130 or in a cover 332 of the transport device 130. The second cross-sectional area may be the sum of the outlet cross-sectional areas of the N corresponding holes 131, 331, 333. Here, the outlet cross-sectional areas for different corresponding holes 131, 331, 333 may be at least partially different. Alternatively, the corresponding holes 131, 331, 333 may have substantially the same outlet cross-sectional area. The outlet cross-sectional area of a hole 131, 331, 333 may correspond to the cross-sectional area of the hole 131, 331, 333 through which fluid is pumped to create a vacuum 132 in the hole 131, 331, 333. For this purpose, the hole 131, 331 333 may have the reduced outlet cross-sectional area at a location between the front and the rear of the conveyor belt 130 (but not directly at the front of the conveyor belt 130).

A transport device 150 is thus described, which is adapted to transport a recording medium 120 on a transport belt 130 through a printing unit 140. The conveyor belt 130 has a plurality of holes 131, 331, 333, which have a first cross-sectional area (in total) towards the recording medium 120. By means of a negative pressure unit 152, fluid (in particular air) is pumped out of the holes 131, 331, 333 and/or through the holes 131, 331, 333 in order to build up a negative pressure 132 in the holes 131, 3331, 333 of the conveyor belt 130. In the process, the fluid is pumped out via a second cross-sectional area that is reduced compared to the first cross-sectional area. As a result, relatively high holding forces on the recording medium 120 can be achieved with relatively low fluid consumption. Preferably, for each individual hole 131, 331, 333, the outlet cross-sectional area used to pump the air out of the hole 131, 331, 333 is smaller than the inlet cross-sectional area of the hole 131, 331, 333 facing the recording medium 120. In this way, a homogeneous force distribution and a further reduction in air consumption can be achieved.

At least one hole 131, 331, 333 (in particular each hole 131, 331, 333) of the plurality of holes 131, 331, 333 may have an inlet cross-sectional area at the front side of the conveyor belt 130. Furthermore, at least one hole 131, 331, 333 (in particular each hole 131, 331, 333) of the plurality of holes 131, 331, 333 may have an outlet cross-sectional area at at least one location on the path between the front side and the rear side of the conveyor belt 130, wherein the inlet cross-sectional area of a hole 131, 331, 333 is respectively larger than the outlet cross-sectional area of the hole 131, 331, 333. In particular, a hole 131, 331, 333 can have the reduced outlet cross-sectional area directly on the rear side of the conveyor belt 130.

For example, a hole 131, 331, 333 may extend at least partially conically from the front side to the rear side of the conveyor belt 130. Alternatively or additionally, the cross-sectional area of the hole 131, 331, 333 may reduce along an axis from the front to the rear of the conveyor belt 130 in one or more steps or continuously from the inlet cross-sectional area to the outlet cross-sectional area. By providing holes 131, 331, 333 with different inlet and outlet cross-sectional areas, a high holding force on the one hand and a relatively low fluid consumption on the other hand can be achieved in a reliable and efficient manner.

The conveyor belt 130 can be multi-layered. In particular, the conveyor belt 130 can have a first layer 330 arranged relatively close to the front side and a second layer 332 arranged relatively close to the rear side, which can be firmly connected to one another. By using a multi-layer conveyor belt 130, different (effective) inlet and outlet cross-sectional areas for the holes 131, 331, 333 can be achieved in an efficient manner.

In particular, the first layer 330 and the second layer 332 can each have corresponding (overlapping) holes 331, 333. One hole 331 of the first layer 330 may have the inlet cross-sectional area. On the other hand, the corresponding hole 333 of the second layer 332 may have the smaller outlet cross-sectional area.

As explained above, a recording medium 120 may have a certain flexibility, and thus may be pulled into a hole 331 of the first layer 330 due to the negative pressure 132. A hole 331 of the first layer 330 may thereby have a center surrounded by the edge of the hole 331 of the first layer 330. The corresponding hole 333 of the second layer 332 can then be arranged between the edge and the center of the hole 331 of the first layer 330. In particular, the corresponding hole 333 of the second layer 332 may be arranged such that the hole 333 of the second layer 332 does not surround an axis extending through the center of the hole 331 of the first layer 330 and standing vertically on the conveyor belt 130. In this way, it can be reliably avoided that the recording medium 120 closes the hole 333 of the second layer 332. Reliable transport of a recording medium 120 can thus be achieved.

Alternatively or additionally, the second layer 332 can include a fluid-permeable material, in particular a mesh and/or a porous material. The fluid-permeable material can be designed in such a way that a fluid flow 133 through a hole 331 in the first layer 330 is throttled by the second layer 332. In particular, the fluid-permeable material and/or the thickness of the second layer 332 can be formed such that the area of the second layer 332 covering a hole 331 of the first layer 331 throttles the fluid flow 133 in the same way as a corresponding hole 333 of the second layer 332 with a reduced outlet cross-sectional area. A second layer 332 made of a fluid-permeable material can thus be used to effectively reduce fluid consumption.

The transport device 150 can have a fixed cover 332 arranged on the rear side of the conveyor belt 130. The cover 332 can be designed to guide the conveyor belt 130 in a stable manner. The movement unit 151 can be arranged to move the conveyor belt 130 over the cover 332. The cover 332 can have a plurality of holes 333, and the vacuum unit 152 can be configured to pump fluid through the plurality of holes 333 of the cover 332 to create the vacuum 132 in the plurality of holes 131 of the conveyor belt 130.

The cover 332 can be configured such that the aperture 632 at least partially covers the plurality of holes 131 of the conveyor belt 130, thereby providing the reduced second cross-sectional area through which fluid is pumped to create the vacuum 132. The use of the guide cover 332 of the transport device 150 can reduce fluid consumption in a particularly efficient manner.

The plurality of holes 333 of the cover 332 and the plurality of holes 131 of the transport belt 130 are preferably formed in such a way that the second cross-sectional area remains substantially constant during operation of the transport device 150 (in particular during any relative movement between the transport belt 130 and the cover 332). In this way, constant holding forces on different recording media 120 and constant fluid flows 133 in gaps 121 between recording media 120 can be brought about, whereby the print quality of a printing device 100 can be increased.

The plurality of holes 333 of the cover 332 can be arranged in such a way that at any time during operation of the transport device 100 (in particular during any relative movement between the conveyor belt 130 and the aperture 632) a hole 131 of the conveyor belt 130, in particular each hole 131 of the plurality of holes 131 of the conveyor belt 130, overlaps with at least one hole 333 of the cover 332 and/or is partially covered by the cover 332. The reduction of the cross-sectional area can thus be distributed over the plurality of holes 131 of the conveyor belt 130, so that a homogeneous distribution of holding forces and air flows can be achieved.

At least one hole 333 (in particular each hole 333) of the cover 332 can have a larger cross-sectional area on a side facing the rear side of the conveyor belt 130 than on a side facing away from the rear side of the conveyor belt 130. For example, a hole 333 of the cover 332 can be cone-shaped. In this way, an accelerated build-up of the negative pressure and thus improved adhesion of a recording medium 120 can be achieved during operation of the transport device 150. Alternatively or additionally, a further reduction of the second cross-sectional area and thus of the fluid consumption can be achieved in this way.

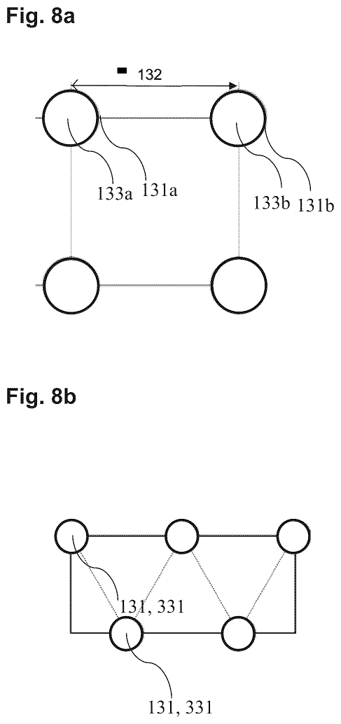

FIGS. 8a and 8b show a top view of a conveyor belt with two conceivable spacing geometries of the holes 131, 331. A distance 132 between the center 133a of a first hole 131a and the center 133b of a second hole is preferably between 25 and 80 mm, more preferably between 50 and 70 mm, even more preferably between 54 and 64 mm, in particular for transport media made of corrugated cardboard with thicknesses between 1 mm and 20 mm. As shown in FIG. 8a, the holes 131a, 131b are arranged particularly in a square spacing geometry. However, triangular geometries as in FIG. 8b or other arrangements are also possible. The holes 131, 331 are arranged here in the form of isosceles triangles.

Furthermore, a printing device 100 is described in this document, which includes the transport device 150 described in this disclosure.

What is claimed is:

1. A transport device for transporting a recording medium through a printing unit of a printing device the transport device comprising:
a conveyor belt;
a movement unit configured to move the conveyor belt through the printing unit,
wherein the conveyor belt includes a plurality of holes,
wherein the conveyor belt is configured to transport the recording medium on a front side of the conveyor belt, and
wherein the plurality of holes on the front side of the conveyor belt has a first cross-sectional area;
a negative pressure unit configured to generate a negative pressure in the plurality of holes of the transport belt by pumping out a fluid, so that a holding force is caused on the recording medium at the first cross-sectional area of the plurality of holes, and
the fluid for building up the negative pressure is pumped out through a second cross-sectional area that is smaller than the first cross-sectional area.

2. The transport device according to claim 1, wherein
at least one hole of the plurality of holes on the front side of the conveyor belt has an inlet cross-sectional area,
the at least one hole has an outlet cross-sectional area at at least one point between the front side and an opposite rear side of the conveyor belt, and
the inlet cross-sectional area is larger than the outlet cross-sectional area.

3. The transport device according to claim 2, wherein
the at least one hole extends in the shape of a cone at least along a section from the front to the rear of the conveyor belt, or
a cross-sectional area of the at least one hole is reduced along an axis from the front side to the rear side of the conveyor belt in one or more steps or continuously from the inlet cross-sectional area to the outlet cross-sectional area.

4. The transport device according to claim 1, wherein
the conveyor belt has a first layer arranged relatively close to the front side and a second layer arranged relatively close to an opposite rear side, which are firmly bonded to one another;
the first layer and the second layer each have corresponding holes; and
a hole of the first layer has an inlet cross-sectional area that is larger than an outlet cross-sectional area of a corresponding hole of the second layer.

5. The transport device according to claim 4, wherein
the hole of the first layer has a center surrounded by an edge of the hole of the first layer,
the corresponding hole of the second layer extends between the edge and the center of the hole of the first layer, and/or
the corresponding hole of the second layer does not enclose an axis extending vertically on the conveyor belt through the center of the hole of the first layer.

6. The transport device according to claim 1, wherein
the conveyor belt has a first layer arranged relatively close to the front side and a second layer arranged relatively close to an opposite rear side, which are firmly bonded to one another;
the first layer has a plurality of holes,
the second layer includes a fluid-permeable material, in particular of a braid and/or a porous material, and
the fluid-permeable material is configured such that a fluid flow through a hole of the plurality of holes of the first layer is throttled by the second layer.

7. The transport device according to claim 1, wherein
the transport device has a fixed aperture arranged on a rear side of the conveyor belt,
the plurality of holes of the conveyor belt each extend from the front side to the rear side of the conveyor belt,
the movement unit moves the conveyor belt along the aperture,
the aperture has a plurality of holes,
the negative pressure unit pumps fluid through the plurality of holes of the aperture to create the negative pressure in the plurality of holes of the conveyor belt, and
the aperture is configured such that the aperture at least partially covers the plurality of holes of the conveyor belt to provide the reduced second cross-sectional area through which fluid is pumped to create the vacuum.

8. The transport device according to claim 7, wherein the plurality of holes of the aperture and the plurality of holes of the transport belt are formed in such a way that the second cross-sectional area remains substantially constant during a relative movement between the transport belt and the aperture.

9. The transport device according to claim 7, wherein the plurality of holes of the aperture are arranged in such a way that, during a relative movement between the transport belt and the aperture, at any time, each hole of the plurality of holes of the transport belt
is drilled through the aperture of the aperture,
overlaps with at least one hole of the aperture, and
is partially covered by the cover.

10. The transport device according to claim 7, wherein a hole of the aperture has a larger cross-sectional area on a side facing the rear side of the conveyor belt than on a side facing away from the rear side of the conveyor belt.
